(19) United States
(12) Patent Application Publication
(10) Pub. No.: US 2002/0056602 A1
(43) Pub. Date: May 16, 2002

(54) Freewheel with reduced wear and noisiness

(75) Inventor: Igino Aurora, Miglianico (IT)

Correspondence Address: BROWDY AND NEIMARK, P.L.L.C., 624 NINTH STREET, NW, SUITE 300, WASHINGTON, DC, 20001-5303, US

(73) Assignee: ROTIS s.r.l., RIPA TEATINA (IT)

(21) Appl. No.: 09/987,393

(22) Filed: Nov. 14, 2001

(30) Foreign Application Priority Data
Nov. 14, 2000 (IT) RM-2000A000590

(51) Int. Cl. F16D 41/12

(52) U.S. Cl. 192/45.1; 192/46

(57) ABSTRACT

Freewheel with reduced wear and noisiness, in which sprags are housed oscillating in respective containment slots obtained in the hub. Said containment slots have at their end a concave wall against which the sprag is to thrust and bear, at the other end a concave wall for holding the sprag and, between one and the other ends, a convex wall having a throat in which is housed a spring. The sprags are able to engage with stepped notches formed circumferentially in the shaft, having, mutually orthogonal, a thrust wall and a bearing surface.

### BACKGROUND OF THE INVENTION

The present invention relates to a freewheel with reduced wear and noisiness. Such a device is used to transmit a torque between two coaxial elements, a shaft and a hub, only in one direction of rotation, whilst the coupling must be torsionally free in the opposite direction of rotation.

A typical use is the one in which the shaft through the hub, or vice versa, sets in rotation large inertial masses which cannot be stooped immediately upon stopping the shaft because they would generate a high return torque with the consequent breakage of mechanical parts. With the freewheel, when the drive shaft stops, the rotating masses can continue to rotate freely until they slow down and stop gradually.

Various kinds of freewheels are commercially available; they are of different design, all having the same operating principle and being mutually differentiated in their embodiments.

A classic example of commonly used Freewheel is the one shown in FIGS. 1 and 2.

In them, the reference letter m indicates the hub, a the shaft, whilst the references l and ml generically indicate, respectively, sprags and springs.

On the shaft a are normally obtained two or more slots ca, sufficiently deep to contain the sprags l with the springs ml which can be helical (and hence with an additional housing hole obtained on the bottom of the slot ca), or flat (with lateral holding elements mounted on the shaft to prevent them from egressing the slot). On the hub, instead, are obtained slots cm filleted with ramp r to the centring diameter between hub and shaft. The slots cm are always in the same number as the sprags or in a multiple thereof.

When the shaft rotates counter-clockwise or the hub rotates clockwise, the sprags l, thrust by the springs ml, rise until they are wedged in the slots cm of the hub, thereby providing a torsionally rigid coupling between the shaft and the hub and hence allowing the mutual transmission of torque.

Conversely, when the shaft rotates clockwise or the hub counter-clockwise, since the hub slides with respect to the shaft, the fillet ramp r acting on the upper edge ss of the sprags, thrusts them downwards against the action of the spring, causing them to recess into the slot ca of the shaft as a result of their rotation whose pivot point is their lower edge si. Thus the hub and the shaft can rotate idle relative to each other.

In an intermediate position, the situation is as shown in FIG. 2. During the mutual rotation, as soon as the edge ss of the sprags uncovers the edge sm of the hub, the sprags l re-open suddenly, thanks to the action of the underlying spring, and then close again. When the mutual rotation of hub and shaft is inverted, the sprags, sliding in the opposite direction on the ramp r, re-open until they reach the stop and mutually fastening the hub and the shaft again. During the “idle” rotation each sudden release of the sprags leads to an impact that generates the characteristic intermittent noise of one-way couplings of this kind.

The disadvantages of this type of freewheel are linked to the fact that the slots of the shaft must be large enough to contain the sprags and, similarly, the slots on the hub with the related ramps large enough to contain the upper profile of the sprags which cannot be reduced to a mere “projection” since in the impact associated with re-coupling it could break. This arrangement considerably reduces the coupling and centring surface between shaft and hub.

Moreover, the slots on the shaft force to use greater centring diameters between hub and shaft to avoid weakening them and above all, when mounting bearings on the shaft, to exceed the mounting diameters of any bushings and bearings.

The increased diameter causes the sliding velocities between sprags, hub and shaft to be very high with their consequent greater stress and wear.

All these drawbacks become very important when said one-way couplings are used, for instance, in so-called motion inverters. In such mechanism the freewheels are used on two hubs keyed on the same shaft. Depending on the direction of rotation of the shaft, one of the hubs always runs idle whilst the other one is always coupled for a large number of hours and at considerable speeds, up to and exceeding 2,000 rpm.

In this case, the continuous impacts of the sprags can disturb those who work in contact with these organs. Therefore, this is not a wholly appropriate use for this kind of organ. The alternative is to use mechanical and manual couplings which, however, in addition to being not automated, are much more expensive to construct.

### SUMMARY OF THE INVENTION

The present invention is aimed at overcoming the aforesaid drawbacks using, in a freewheel, particular geometries of the slots and of the sprags, such as to attribute to the latter a wholly different motion.

In particular, an aim of the invention is to obtain, with the same dimensions as a conventional device, a freewheel with superior resistance to stress and in particular to wear.

In general, another aim of the invention is to provide freewheels of reduced size.

A further aim of the invention is to reduce noisiness relative to traditional freewheels.

Therefore, the present invention provides a freewheel with reduce wear and noisiness, comprising a hub, a cylindrical shaft and a series of sprags for the mutual coupling of one and the other in only one direction of rotation, which, from a general viewpoint, is characterized in that:

said sprags, having prismatic shape with a concave face oriented towards the shaft, are housed and constrained to oscillate about an axis of rotation in respective containment slots obtained in the hub; said slots having at their end a concave wall for the sprag to thrust and bear upon, at the other end a concave wall for holding the sprag, and, between one and the other end, a convex wall having an edge to impart the rotation motion to the sprag and at least a throat in which a related spring is housed;

said sprag being able to engage stepped notches formed circumferentially in the shaft, having mutually orthogonal, a thrust wall and a bearing surface ending with an edge which in the engaged position falls inside the concave face of the sprag.

### BRIEF DESCRIPTION OF THE DRAWINGS

Further characteristics and advantages of the present invention shall become more readily apparent from the detailed description that follows, of preferred embodiments illustrated purely by way of non limiting example in the accompanying drawings, in which:

FIG. 1 is a cross section of a prior art freewheel in the engaged condition;

FIG. 2 is a cross section of the freewheel of FIG. 1 in an intermediate condition between engagement and release;

FIG. 3 is a cross section of the hub of a freewheel according to the present invention;

FIG. 4 is a section of the shaft of the freewheel according to the present invention;

FIG. 5 is a lateral view of a sprag for the freewheel according to the present invention;

FIG. 6 is a cross section of the freewheel according to the present invention in the engaged condition;

FIGS. 7 through 10 are partial cross sections of the freewheel according to the present invention in successive phases between the engaged and the release condition;

FIG. 11 is a partial cross section, in enlarged scale, of a variation of the freewheel according to the present invention in the engaged condition;

FIG. 12 is a partial cross section, in enlarged scale, of the variation of FIG. 11 in the release condition;

FIG. 13 is a section obtained according to the line A-A of FIG. 6.

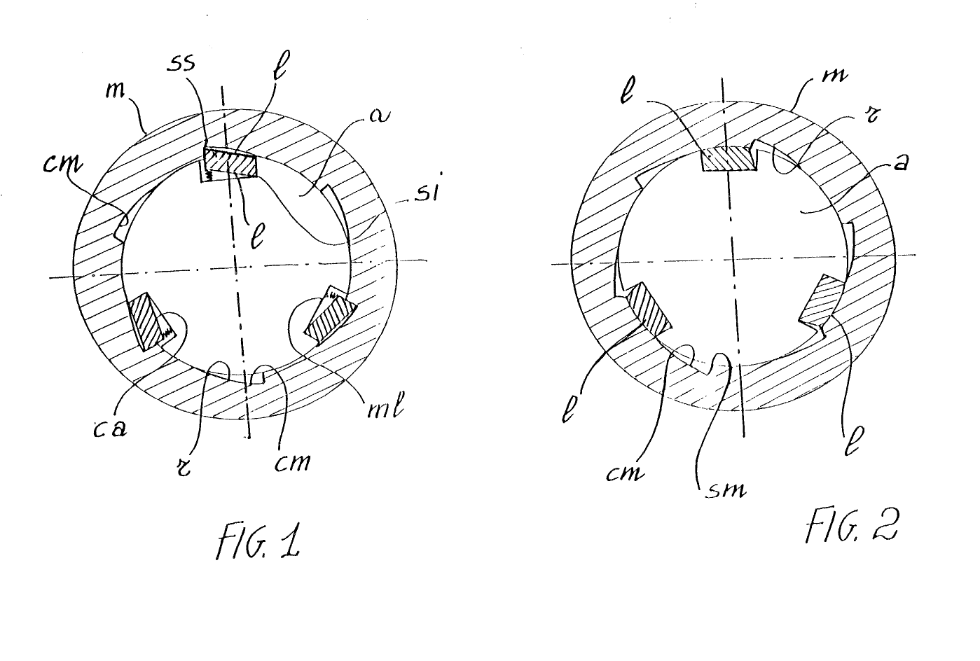

### DESCRIPTION OF THE PREFERRED EMBODIMENTS

With particular reference to FIGS. 3, 4 and 5, which are respective views of the components of the freewheel according to an embodiment of the invention, in a hub 1, in its inner surface 10 for centring and coupling with a coaxial shaft 4, are obtained containment slots, generically indicated with the reference 2, for sprags generically indicated with the reference 3. Each sprag 3, of substantially prismatic shape with a concave face oriented towards the shaft, is contained between the slot 2 of the hub 1 and the shaft 4 in such a way as to rotate about an axis passing inside the prismatic section of the sprag.

In the homologous exterior surface 40 of the shaft 4 for centring and coupling with the hub 1, stepped notches 5 for the sprags 3 are obtained. The stepped notches 5 are in the same number as the containment slots 2, or in a multiple thereof. The number of containment slots 2 is equal to that of the sprags 3. In the described or illustrated embodiment, there are three slots on the hub, hence three sprags, and six notches on the shaft.

According to the present invention, in the profile of the containment slot 2 are provided parts operatively corresponding to homologous parts formed in the profile of the sprag 3:

a concave thrust and bearing wall 20 on the hub 1 of a homologous face 30 of the sprag 3 during torque transmission;

a convex wall 21 having an edge that goes to abut on a face 31 of the sprag 3 during its rotation, to impart the correct motion thereto;

a throat 22 for a flat blade, as shown hereafter, or possibly for one or more helical springs;

a concave 23 wall for retaining the sprag 3, having substantially circular shape with radius equal to the maximum radius of rotation of a corresponding face 34 of the sprag 3, in such a way as to allow the oscillation thereof;

As in the containment slots 2, in the profile of each stepped notch 5 of the shaft 4 are provided parts operatively corresponding to homologous parts formed in the profile of the sprag 3;

a thrust wall 50 on the shaft 4 of the homologous face 34 of the sprag 3;

a bearing surface 51 of the sprag 3 such as to limit its recessing run;

an edge 52 that, in the engaged position, goes to abut on a face 35 of the sprag 3, having the same radius of curvature as the surfaces 10 and, respectively, 40 of the hub and of the shaft, to impart, in opposition to the edge of the convex wall 21, the initial rotation of the sprag 3.

The thrust wall 50 and the bearing surface 51, both secant relative to the cylinder of the shaft 4, form a substantially right angle between them. The thrust wall 50 lies in an ideal plane that is offset relative to the shaft.

With reference to FIG. 6, the engagement position is shown of the sprags thrust by springs 6 so that if the shaft 4 were to rotate counter-clockwise (or the hub 1 clockwise), motion and hence torque would be transmitted between the two components.

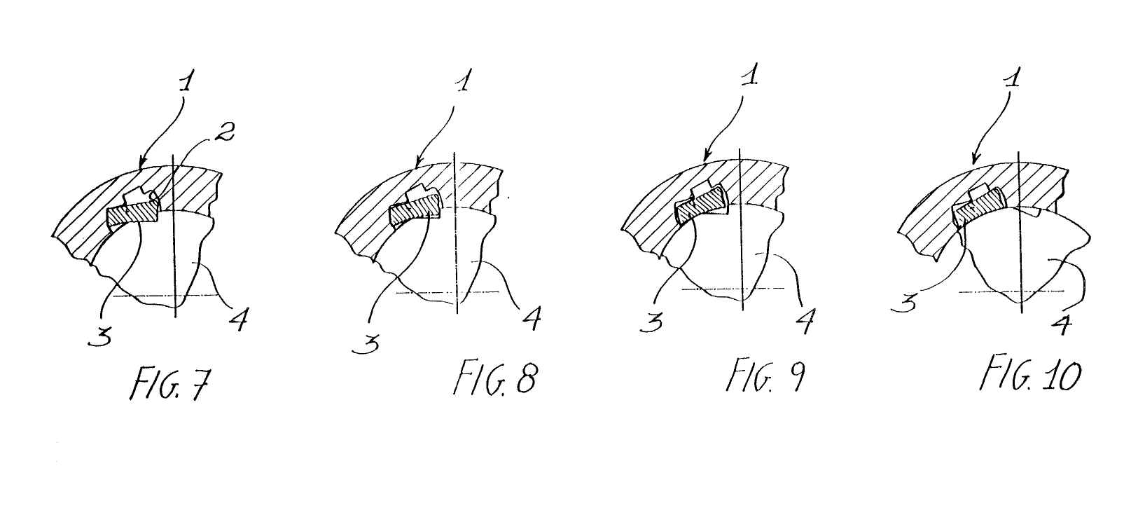

In regard to the operation of the device, reference is made to FIGS. 7 through 10, in which, for the sake of simplicity, only one sprag is shown to illustrate the passage from a condition in which the hub 1 and the shaft 4 are in integral rotary motion to a condition in which they are idle relative to each other.

In the condition of integral motion the face 35 of the sprag 3 is positioned in proximity, ideally in contact, with the edge 52 of the shaft 4 as well as the wall 20 of the slot 2 of the hub 1 and the wall 50 of the notch 5 of the shaft 4 are respectively in contact with the face 30 and 34 of the sprag 3.

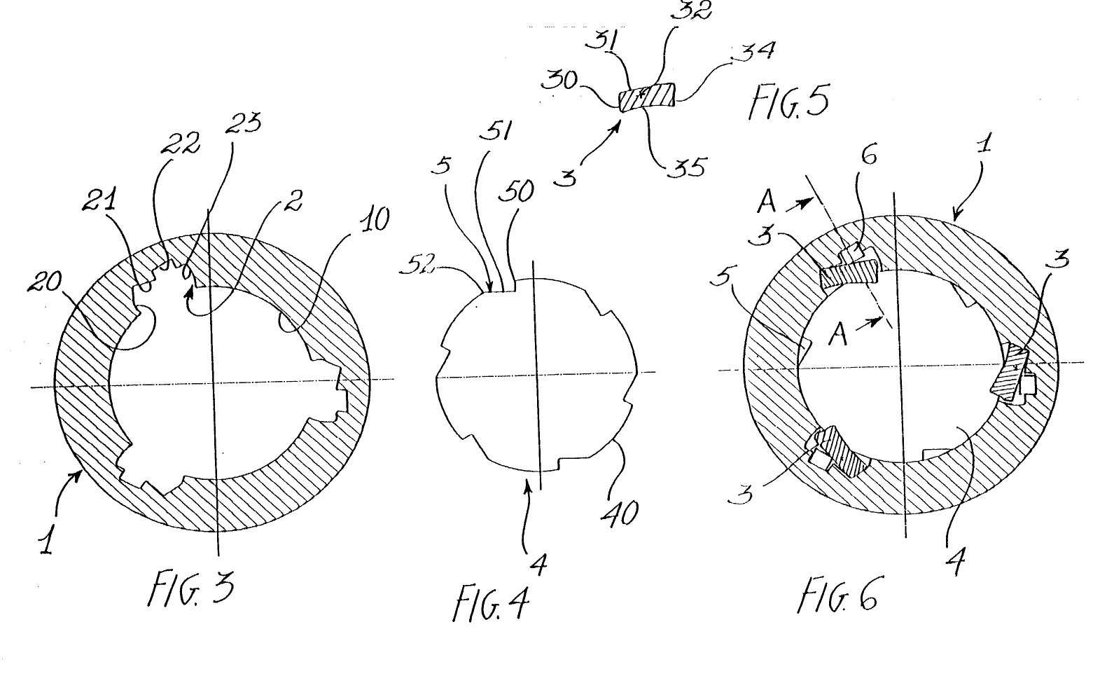

All this is possible also because, as shown in FIG. 4, the stepped notch 5 obtained in the shaft 4 is positioned to one side relative to the vertical axis of symmetry of the shaft. This allows to have a very small stepped notch 5 relative to the dimensions of the sprag 3 and hence also a narrow bearing surface 51 able to allow the edge 52 to be roughly in proximity to the central part of the curved face 35 of the sprag 3.

Rotating the shaft 4 clockwise, or the hub 1 counter-clockwise, the edge 52 of the shaft 4, in motion relative to the hub 1 and hence to the sprag 3, thrusts the latter in contact with its face 31 against the edge of the retaining slot 3 in the hub 1. This generates a couple of forces that causes the sprag to rotate about an axis ideally passing through the point 32. It should be recalled that in the example of the prior art, the rotation of the sprag 3 takes place relative to one of its end edges “si”.

Still with reference to FIGS. 7 through 10, with the advancement of the relative rotation of the shaft with respect to the hub (or vice versa), the sprag 3 rotates more and more, against the action of the spring 6 until the sprag 3 bears with its face 35 on the circumferential periphery 40 of the shaft 4.

Thanks to the particular arrangement according to the invention, it is noted that, the shaft 4 continuing to rotate idle relative to the hub 1, the sprag 3, even when it uncovers the entire stepped notch 5 of the shaft 4 it does not immediately impact against the stepped notch 5 if not ideally in the instant in which it is in the engagement condition shown in FIG. 7. But, especially at high relative velocities, the sprag 3 does not have time to reach the end stop because the edge 52 of the stepped notch 5, which is always in contact with the face 35 of the sprag 3, together with the wall 21 of the hub, for rotation just subsequent to the limit one of FIG. 7, causes the sprag 3 to stop its run and in fact to return immediately.

This is also favoured by the fact that the sprag, having an axis of rotation internal to its profile acquires a lesser peripheral velocity than it would if it were to rotate about its end edge as in the prior art.

All this results in reduced noisiness of the freewheel.

Another considerable advantage is that, since the slot on the shaft is very small relative to the slot of the hub and going to a slight depth thereon, for the same minimum limit diameter between this solution and the more traditional one, it is possible to work on a far smaller shaft diameter, closer to the minimum limit diameter with the reduction of the peripheral velocities of mutual sliding. Moreover, even working on a smaller diameter, the reduced size of the notches 5 on the shaft 4 coupled to the minimal dimensions of the slots of the hub 1, causes the contact and centring surface 40 of the shaft 4 to be considerably larger, hence with a better distribution of the loads and of the mutual support between the two.

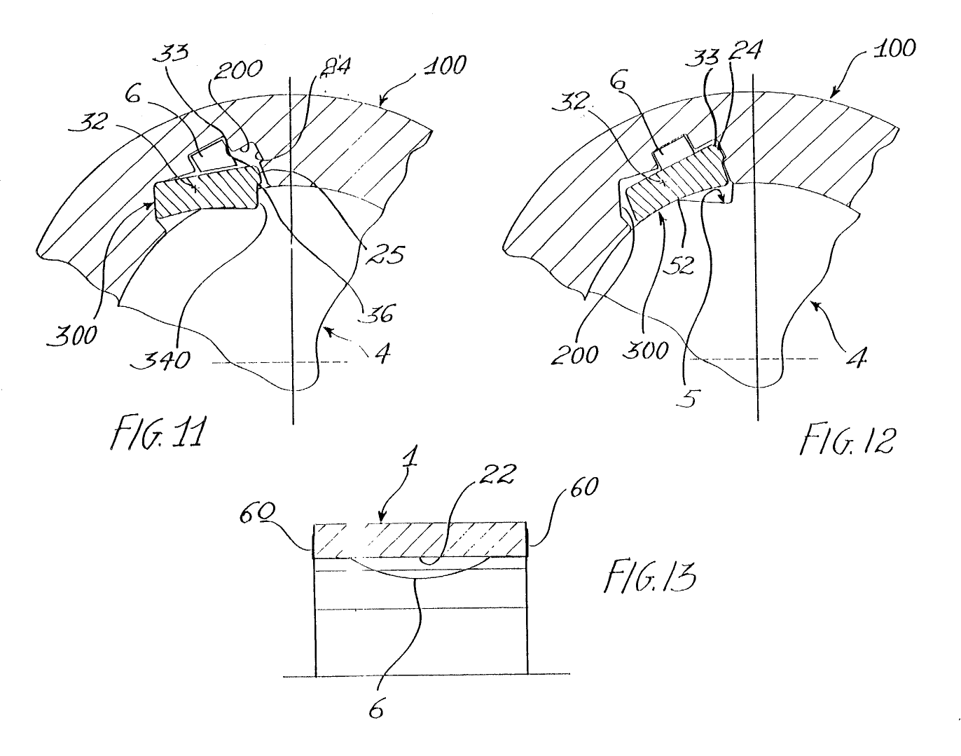

The re-engagement of the shaft and of the hub is also performed gradually as can be perceived rotating the shaft counter-clockwise (or the hub clockwise), as shown observing FIGS. 10 through 17.

With reference to FIGS. 11 and 12, a variation of the embodiment described above is shown, where similar or equal reference numbers are used for corresponding parts.

In a retaining slot 200 of a hub 100 is obtained, in its wall 23, an additional recess 24. Said recess 24 has such dimensions, shape and disposition as to allow the introduction of a protuberance 33 formed in a face 340 of a sprag 300 oriented towards the retaining concave part 23 of the slot 200. The recess 24 is delimited by a step 25 destined to engage with a corresponding projection 36 of the protuberance 33. The step 25 of the slot 200 and the corresponding projection 36 of the sprag 3 are appropriately oriented in such a way that, rotating the shaft clockwise relative to the hub, the sprag 300 is also thrust to rotate slightly clockwise about the axis of the shaft 4 until the projection 36 of the sprag 300 goes to bear on the step 25 of the slot 200. In this way, as shown in FIG. 12, the shaft 4 continuing to rotate clockwise relative to the hub, or vice versa, the dynamic friction between the shaft 4 and the sprag 300, favoured by the viscosity of the lubricating oil holds the sprag bearing on the step 25 of the slot 200 on the hub, and thus opposing the force of the spring 6 it causes the sprag 300 not to snap into the notch 5 of the shaft, to block the rotation of the shaft relative to the hub 100.

According to the present invention, a particular conformation of the flat spring 6 is provided, shown better in FIGS. 13 and 14 which are cross sections of the spring along the line A-A of FIG. 6, when seen in the throat 22 serving as a seat or when seen by itself

The spring 6 has fins 6 which, once the spring is mounted in the throat 22 of the hub 1 and the shaft 4 and the sprag 3 are inserted, cause the spring 6 to be perfectly housed in its seat and unable to egress therefrom in any way. The fins 60 bear against the end faces of the hub 1, said faces being wide enough to encompass its entire thickness, so that the spring 6 cannot translate along the axis of the hub 1 egressing therefrom.

As a positive consequence of this solution for fabricating the spring, which became self-locking, no additional components or particular work processes are necessary to lock the spring in its seat, with obvious advantages from the viewpoint of mounting simplicity or lower overall cost.

The invention thus conceived can be subject to numerous modifications and is variations, without thereby departing from the scope of the inventive concept.

What is claimed:

1. Freewheel with reduced wear and noisiness, comprising a hub, a cylindrical shaft and a series of sprags for the mutual coupling of one and the other in a single direction of rotation, wherein
said sprags, having a prismatic shape with a concave face oriented towards the shaft are housed and constrained to oscillate about an axis of rotation, having as a trace the point, in respective containment slots obtained in the hub; said containment slots having at their end a concave wall whereupon the sprag thrusts and bears, at the other end a concave wall for retaining the sprag, and, between one and the other end, a convex wall having an edge for imparting the rotation motion to the sprag and at least a throat in which a spring is housed;
said sprags being able to engage with stepped notches formed circumferentially in the shaft, having, mutually orthogonal, a thrust wall and a bearing surface ending with an edge, which in the engaged position falls inside the concave face of the sprag.

2. Freewheel as claimed in claim 1, wherein said axis of oscillation has for a trace a point interior to the prismatic section of the sprag.

3. Freewheel as claimed in claim 1, wherein said sprag, in its face oriented towards the concave retaining wall of the slot, has a protuberance destined to be received in a recess obtained in the concave wall and delimited by a step engaging with a corresponding projection of the protuberance.

4. Freewheel as claimed in claim 1, wherein said spring is a flat spring having radial end fins.
